(19) United States
(12) Patent Application Publication
(10) Pub. No.: US 2016/0062510 A1
(43) Pub. Date: Mar. 3, 2016

(54) CONDUCTIVE FILM AND IMAGE DISPLAY DEVICE

(71) Applicant: NITTO DENKO CORPORATION, Ibaraki-shi, Osaka (JP)

(72) Inventors: Hiroshi Tomohisa, Ibaraki-shi (JP); Shouichi Matsuda, Ibaraki-shi (JP); Hiroyuki Takemoto, Ibaraki-shi (JP); Tadayuki Kameyama, Ibaraki-shi (JP)

(73) Assignee: NITTO DENKO CORPORATION, Ibaraki-shi, Osaka (JP)

(21) Appl. No.: 14/782,093

(22) PCT Filed: Apr. 1, 2014
(86) PCT No.: PCT/JP2014/059618

§ 371 Date: Oct. 2, 2015

(30) Foreign Application Priority Data
Apr. 4, 2013 (JP) 2013-078516
Apr. 1, 2014 (JP) 2014-075014

(51) Int. Cl. G06F 3/044; G02B 5/30; G02F 1/13363; G02F 1/1333; G02F 1/1335

(52) U.S. Cl. CPC G06F 3/044; G02F 1/13338; G02F 1/133528; G02F 1/13363; G02B 5/3083

(57) ABSTRACT

A conductive film is provided which is excellent in bending resistance, conductivity is not impaired even when the film is bent, and when the film is applied to an image display apparatus including a polarizing plate, the film can contribute to an improvement in visibility through a polarizing lens. A conductive film includes a retardation film; and a transparent conductive layer arranged on at least one surface of the retardation film, wherein: the retardation film has an in-plane retardation at a wavelength of 550 nm of from 90 nm to 190 nm; a ratio (Re[400]/Re[550]) of an in-plane retardation Re[400] of the retardation film at a wavelength of 400 nm to the in-plane retardation Re[550] of the retardation film at a wavelength of 550 nm is from 0.5 to 0.9; and the transparent conductive layer includes at least one of a conductive nanowire, a metal mesh, and a conductive polymer.

### TECHNICAL FIELD

The present invention relates to a conductive film and an image display apparatus.

### BACKGROUND ART

At transparent conductive film obtained by forming a metal oxide layer such as an indium-tin composite oxide (ITO) layer on a transparent resin film has heretofore been frequently used as an elect rode for a touch sensor in an image display apparatus including the touch sensor. However, the transparent conductive film including the metal oxide layer involves a problem in that it is difficult to use the film in applications where bending resistance is required such as a flexible display because the conductivity of the film is liable to be lost by its bending.

Meanwhile, when the display screen of an image display apparatus including a polarizing plate such as a liquid crystal display apparatus is viewed through a polarizing lens such as a pair of polarizing sunglasses, there may occur a problem in that an image cannot be viewed or color unevenness is viewed.

### CITATION LIST

### Patent Literature

[PTL 1] JP 2000-112663 A

### SUMMARY OF INVENTION

### Technical Problem

The present invention has been made to solve the problems, and an object of the present invention is to provide the following conductive film. The film is excellent in bending resistance, its conductivity is not impaired even when the film is bent, and when the film is applied to an image display apparatus including a polarizing plate, the film can contribute to an improvement in visibility through a polarizing lens.

### Solution to Problem

A conductive film of the present invention includes a retardation film; and a transparent conductive layer arranged on at least one surface of the retardation film, wherein: the retardation film has an in-plane retardation at a wavelength of 550 nm of from 90 nm to 190 nm; a ratio (Re[400]/Re[550]) of an in-plane retardation Re[400] of the retardation film at a wavelength of 400 nm to the in-plane retardation Re[550] of the retardation film at a wavelength of 550 nm is from 0.5 to 0.9; and the transparent conductive layer comprises at least one kind selected from the group consisting of a conductive nanowire, a metal mesh, and a conductive polymer.

In one embodiment of the present invention, the conductive nanowire or the metal mesh includes one or more kinds of metals selected from the group consisting of gold, platinum, silver, and copper.

In one embodiment of the present invention, the conductive nanowire contains a carbon nanotube.

In one embodiment of the present invention, a ratio (L/d) of a length L of the conductive nanowire to a thickness d of the conductive nanowire is from 10 to 100,000.

In one embodiment of the present invention, the conductive polymer includes one or more kinds of polymers selected from the group consisting of a polythiophene-based polymer, a polyacetylene-based polymer, a poly-p-phenylene-based polymer, a polyaniline-based polymer, a poly-p-phenylene vinylene-based polymer, and a polypyrrole-based polymer.

According to another aspect of the present invention, there is provided an image display apparatus. The image display apparatus includes the conductive film and a polarizing plate in the stated order from a viewer side.

In one embodiment of the present invention, the image display apparatus is free of a polarizing plate arranged on the viewer side of the conductive film.

According to another aspect of the present invention, there is provided touch panel. The touch panel includes the conductive film.

### Advantageous Effects of Invention

According to the present invention, the conductive film includes the retardation film having a specific retardation, and the transparent conductive layer including at least one kind selected from the group consisting of the conductive nanowire, the metal mesh, and the conductive polymer, whereby the following conductive film can be obtained. The film is excellent in bending resistance, its conductivity is not impaired even when the film is bent, and when the film is applied to an image display apparatus including a polarizing plate, the film can contribute to an improvement in visibility through a polarizing lens.

### BRIEF DESCRIPTION OF DRAWINGS

FIG. 1 is a schematic sectional view of a conductive film according to a preferred embodiment of the present invention.

FIG. 2 is a schematic sectional view for illustrating an example of an image display apparatus including the conductive film of the present invention.

FIG. 3 is a schematic sectional view for illustrating another example of the image display apparatus including the conductive film of the present invention.

FIG. 4 is a schematic sectional view for illustrating another example of the image display apparatus including the conductive film of the present invention.

FIG. 5 is a schematic sectional view for illustrating another example of the image display apparatus including the conductive film of the present invention.

FIG. 6 is a graph for showing the wavelength dispersion characteristics of retardation films used in Example 1 and Comparative Example 1.

### DESCRIPTION OF EMBODIMENTS

A. Entire Construction of Conductive Film

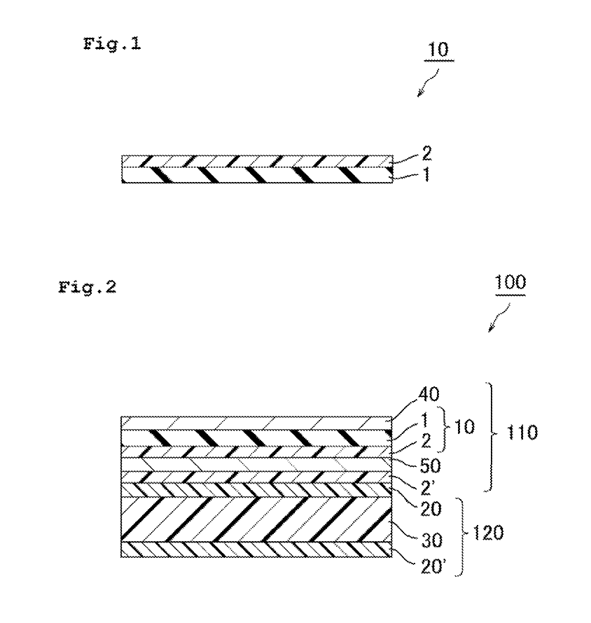

FIG. 1 is a schematic sectional view of a conductive film according to a preferred embodiment of the present invention. A conductive film 10 of FIG. 1 includes a retardation film 1 and a transparent conductive layer 2 arranged on one surface, or each of both surfaces, of the retardation film 1 (one surface in the illustrated example). The transparent conductive layer 2 includes at least one kind selected from the group consisting of a conductive nanowire, a metal mesh, and a conductive polymer. The transparent conductive layer 2 includes the conductive nanowire, the metal mesh, or the conductive polymer, and hence the layer is excellent in bending resistance and its conductivity is hardly lost even when the layer is bent. The conductive nanowire may be protected with a protective layer.

The total light transmittance of the conductive film of the present invention is preferably 80% or more, more preferably 85% or more, particularly preferably 90% or more. For example, when the conductive nanowire is used, a transparent conductive layer having formed therein an opening portion can be formed can be formed, and hence a conductive film having a high light transmittance can be obtained.

The surface resistance value of the conductive film of the present invention is preferably from 0.1Ω/□ to 1,000Ω/□, more preferably from 0.5Ω/□ to 500Ω/□, particularly preferably from 1Ω/□ to 250 Ω/□.

B. Retardation Film

The retardation film can function as the so-called λ/4 plate. The term “λ/4 plate” as used herein refers to a plate having a function of transforming linearly polarized light having a specific wavelength into circularly polarized light (or transforming circularly polarized light into linearly polarized Light). The in-plane retardation Re of the retardation film at a wavelength of 550 nm is from 90 nm to 190 nm, preferably from 100 nm to 160 nm, more preferably from 110 nm to 170 nm. The conductive film of the present invention includes a retardation film having such in-plane retardation Re, and hence when the film is applied to an image display apparatus including a polarizing plate, the film can contribute to an improvement in visibility through a polarizing lens. It should be noted that the in-plane retardation Re in this description is determined by the equation “Re=(nx−ny)×d” where nx represents a refractive index in a direction in which an in-plane refractive index becomes maximum under 23° C. (i.e., a slow axis direction), ny represents a refractive index in a direction perpendicular to the slow axis in a plane (i.e., a fast axis direction), and d represents the thickness (nm) of the retardation film. The retardation film shows any appropriate refractive index ellipsoid as long as the ellipsoid has a relationship of nx>ny. For example, the refractive index ellipsoid of the retardation film shows a relationship of nx>nz>ny or nx>ny≧nz.

The retardation film shows such a wavelength dispersion characteristic that its in-plane retardation Re increases at longer wavelengths. Specifically, the ratio (Re[400]/Re[550]) of the in-plane retardation Re[400] of the retardation film at a wavelength of 400 nm to the in-plane retardation Re[550] of the film at a wavelength of 550 nm is from 0.5 to 0.9, preferably from 0.6 to 0.8. The conductive film of the present invention includes a λ/4 plate showing such wavelength dispersion characteristic as a retardation film, and hence when the film is applied to an image display apparatus including a polarizing plate, the film can contribute to an improvement in visibility through a polarizing lens. In ordinary cases, the problem of the visibility through the polarizing lens (specifically, for example, a problem in that an image is viewed as being colored or discolored, or a rainbow patchy pattern is viewed) becomes remarkable when the quantity of light to be output from the image display apparatus is large. One result of the present invention lies in that an increase in transmittance of a conductive film itself can be realized by using a transparent conductive layer having a high light transmittance, and a conductive film that can contribute to an improvement in visibility through a polarizing lens is obtained.

In one embodiment, the thickness direction retardation Rth of the retardation film at a wavelength of 550 nm is preferably from 45 nm to 85 nm, more preferably from 50 nm to 80 nm, particularly preferably from 55 nm to 75 nm. In this embodiment, the Nz coefficient of the retardation film at a wavelength of 550 nm is preferably from 0.4 to 0.95, more preferably from 0.4 to 0.8. It should be noted that the term “thickness direction retardation Rth” as used herein refers to a thickness direction retardation value at 23° C. The Rth is determined by the equation “Rth=(nx−nz)×d” where nx represents the refractive index in the direction in which the in-plane refractive index becomes maximum (i.e., the slow axis direction), nz represents a thickness direction refractive index, and d represents the thickness (nm) of the retardation film. The Nz coefficient is determined by the equation “Nz=Rth/Re”.

In another embodiment, the thickness direction retardation Rth of the retardation film at a wavelength of 550 nm is preferably from 90 nm to 230 nm, more preferably from 100 nm to 200 nm, particularly preferably from 110 nm to 180 nm, most preferably from 110 nm to 165 nm. In this embodiment, the Nz coefficient of the retardation film at a wavelength of 550 nm is preferably from 1.0 to 1.3, more preferably from 1.0 to 1.25, still more preferably from 1.0 to 1.2, particularly preferably from 1.0 to 1.15.

The thickness of the retardation film may be set so as to obtain a desired in-plane retardation. Specifically, the thickness of the retardation film is preferably from 30 μm to 130 μm, more preferably from 35 μm to 125 μm, particularly preferably from 40 μm to 120 μm.

The retardation film can be formed of any appropriate material as long as the effects of the present invention are obtained. The material is typically, for example, a stretched film of a polymer film. A resin forming the polymer film is, for example, a polycarbonate-based resin having a fluorene skeleton (described in, for example, JP 2002-48919 A) or a cellulose-based resin (described in, for example, JP 2003-315538 A or JP 2000-1.37116 A). In addition, a stretched film of a polymer material containing two or more kinds of aromatic polyester polymers having different wavelength dispersion characteristics (described in, for example, JP 2002-14234 A), a stretched film of a polymer material containing a copolymer having two or more kinds of monomer units derived from monomers forming polymers having different wavelength dispersion characteristics (described in WO 00/26705 A1), or a composite film obtained by laminating two or more kinds of stretched films having different wavelength dispersion characteristics (described in JP 02-120804 A) may be used as the retardation film.

The formation material for the polymer film may be, for example, a homopolymer, a copolymer, or a blend of a plurality of polymers. In the case of the blend, the respective polymers are preferably compatible with each other because the blend needs to be optically transparent. In addition, the refractive indices of the respective polymers are preferably substantially equal to each other. A polymer described in, for example, JP 2004-30961.7 A can be preferably used as the formation material for the retardation film.

Specific examples of the combination of the blend include: a combination of poly(methyl methacrylate) as a polymer having a negative optical anisotropy and poly(vinylidene fluoride), poly(ethylene oxide), a vinylidene fluoride/trifluoroethylene copolymer, or the like as a polymer having a positive optical anisotropy; a combination of polystyrene, a styrene/lauroylmaleimide copolymer, a styrene/cyclohexylmaleimide copolymer, a styrene/phenylmaleimide copolymer, or the like as a polymer having a negative optical anisotropy and poly(phenylene oxide) as a polymer having a positive optical anisotropy; a combination of a styrene/maleic anhydride copolymer as a polymer having a negative optical anisotropy and polycarbonate as a polymer having a positive optical anisotropy; and a combination of an acrylonitrile/styrene copolymer as a polymer having a negative optical anisotropy and an acrylonitrile/butadiene copolymer as a polymer having a positive optical anisotropy. Of those, a combination of polystyrene as a polymer having a negative optical anisotropy and poly(phenylene oxide) as a polymer having a positive optical anisotropy is preferred from the viewpoint of transparency. An example of the poly(phenylene oxide) is poly(2,6-dimethyl-1,4-phenylene oxide).

Examples of the copolymer include a butadiene/styrene copolymer, an ethylene/styrene copolymer, an acrylonitrile/butadiene copolymer, an acrylonitrile/butadiene/styrene copolymer, a polycarbonate-based copolymer, a polyester-based copolymer, a polyester carbonate-based copolymer, and a polyarylate-based copolymer. In particular, the following is preferred because a segment having a fluorene skeleton may have a negative optical anisotropy: polycarbonate having a fluorene skeleton, a polycarbonate-based copolymer having a fluorene skeleton, polyester having a fluorene skeleton, a polyester-based copolymer having a fluorene skeleton, polyester carbonate having a fluorene skeleton, a polyester carbonate-based copolymer having a fluorene skeleton, polyarylate having a fluorene skeleton, a polyarylate-based copolymer having a fluorene skeleton, or the like.

The retardation film can be formed by stretching the polymer film. The in-plane retardation and thickness direction retardation of the retardation film can be controlled by adjusting the stretching ratio and stretching temperature of the polymer film.

The stretching ratio may appropriately vary depending on, for example, an in-plane retardation and thickness direction retardation which the retardation film is desired to have, a thickness which the retardation film is desired to have, the kind of a resin to be used, and the thickness and stretching temperature of the polymer film to be used. Specifically, the stretching ratio is preferably from 1.1 times to 2.5 times, more preferably from 1.25 times to 2.45 times, still more preferably from 1.4 times to 2.4 times.

The stretching temperature may appropriately vary depending on, for example, an in-plane retardation and thickness direction retardation which the retardation film is desired to have, a thickness which the retardation film is desired to have, the kind of a resin to be used, and the thickness and stretching ratio of the polymer film to be used. Specifically, the stretching temperature is preferably from 100° C. to 250° C., more preferably from 105° C. to 240° C., still more preferably from 110° C. to 240° C.

Any appropriate method is adopted as a stretching method as long as such optical characteristics and thickness as described above are obtained. Specific examples thereof include free-end stretching and fixed-end stretching. Free-end uniaxial stretching is preferably employed and free-end longitudinal uniaxial stretching is more preferably employed.

C. Transparent Conductive Layer

The transparent conductive layer includes at least one kind selected from the group consisting of a conductive nanowire, a metal mesh, and a conductive polymer.

C-1. Conductive Nanowire

Any appropriate conductive nanowire can be used as the conductive nanowire as long as the effects of the present invention are obtained. The conductive nanowire refers to a conductive substance that has a needle- or thread-like shape and has a diameter of the order of nanometers. The conductive nanowire may be linear or may be curved. When a transparent conductive layer including the conductive nanowire is used, a conductive film excellent in bending resistance can be obtained. In addition, when a transparent conductive layer including the conductive nanowire is used, pieces of the conductive nanowire form a gap therebetween to be formed into a network shape. Accordingly, even when a small amount of the conductive nanowire is used, a good electrical conduction path can be formed and hence a conductive film having a small electrical resistance can be obtained. Further, the conductive nanowire is formed into a network shape, and hence an opening portion is formed in a gap of the network. As a result, a conductive film having a high light transmittance can be obtained. Examples of the conductive nanowire include a metal nanowire containing a metal and a conductive nanowire including a carbon nanotube.

A ratio (aspect ratio: L/d) between a thickness d and a length L of the conductive nanowire is preferably from 10 to 100,000, more preferably from 50 to 100,000, particularly preferably from 100 to 10,000. When a conductive nanowire having such large aspect ratio as described above is used, the conductive nanowire satisfactorily intersects with itself and hence high conductivity can be expressed with a small amount of the conductive nanowire. As a result, a conductive film having a high light transmittance can be obtained. It should be noted that the term “thickness of the conductive nanowire” as used herein has the following meanings: when a section of the conductive nanowire has a circular shape, the term means the diameter of the circle; when the section has an elliptical shape, the term means the short diameter of the ellipse; and when the section has a polygonal shape, the term means the longest diagonal of the polygon. The thickness and length of the conductive nanowire can be observed with a scanning electron microscope or a transmission electron microscope.

The thickness of the conductive nanowire is preferably less than 500 nm, more preferably less than 200 nm, particularly preferably from 10 nm to 100 nm, most preferably from 10 nm to 50 nm. When the thickness falls within such range, a transparent conductive layer having a high light transmittance can be formed.

The length of the conductive nanowire is preferably from 2.5 μm to 1,000 μm, more preferably from 10 μm to 500 μm, particularly preferably from 20 μm to 100 μm. When the length falls within such range, a conductive film having high conductivity can be obtained.

Any appropriate metal can be used as a metal constituting the metal nanowire as long as the metal has high conductivity. The metal nanowire preferably contains one or more kinds of metals selected from the group consisting of gold, platinum, silver, and copper. Of those, silver, copper, or gold is preferred from the view point of conductivity, and silver is more prefer red. In addition, a material obtained by subjecting the metal to metal plating (e.g., gold plating) may be used.

Any appropriate method can be adopted as a method of producing the metal nanowire. Examples thereof include: a method involving reducing silver nitrate in a solution; and a method involving causing an applied voltage or current to act on a precursor surface from the tip portion of a probe, drawing a metal nanowire at the tip portion of the probe, and continuously forming the metal nanowire. In the method involving reducing silver nitrate in the solution, a silver nanowire can be synthesized by performing the liquid-phase reduction of a silver salt such as silver nitrate in the presence of a polyol such as ethylene glycol and polyvinyl pyrrolidone. The mass production of a silver nanowire having a uniform size can be performed in conformity with a method described in, for example, Xia, Y. et al., Chem. Mater. (2002), 14, 4736-4745 or Xia, Y. et al., Nano letters (2003), 3 (7), 955-960.

Any appropriate carbon nanotube can be used as the carbon nanotube. For example, the so-called multi-walled carbon nanotube, double-walled carbon nanotube, or single-wailed carbon nanotube is used. Of those, the single-walled carbon nanotube is preferably used because of its high conductivity. Any appropriate method can be adopted as a method of producing the carbon nanotube. A carbon nanotube produced by an arc discharge method is preferably used. The carbon nanotube produced by the arc discharge method is preferred because of its excellent crystailinity.

The transparent conductive layer including the conductive nanowire can be formed by applying, onto the retardation film, a dispersion liquid (conductive nanowire dispersion liquid) obtained by dispersing the conductive nanowire in a solvent, and then drying the applied layer.

Examples of the solvent to be incorporated into the conductive nanowire dispersion liquid include water, an alcohol-based solvent, a ketone-based solvent, an ether-based solvent, a hydrocarbon-based solvent, and an aromatic solvent. Water is preferably used from the viewpoint of a reduction in environmental load.

The dispersion concentration of the conductive nanowire in the conductive nanowire dispersion liquid is preferably from 0.1 wt % to 1 wt %. When the dispersion concentration falls within such range, a transparent conductive layer excellent in conductivity and light transmittance can be formed.

The conductive nanowire dispersion liquid may further contain any appropriate additive depending on purposes. Examples of the additive include an anticorrosive material for preventing the corrosion of the conductive nanowire and a surfactant for preventing the agglomeration of the conductive nanowire. The kinds, number, and amount of additives to be used can be appropriately set depending on purposes. In addition, the conductive nanowire dispersion liquid may contain any appropriate binder resin as required as long as the effects of the present invention are obtained.

Any appropriate method can be adopted as an application method for the conductive nanowire dispersion liquid. Examples of the application method include spray coating, bar coating, roll coating, die coating, inkjet coating, screen coating, dip coating, slot die coating, a relief printing method, an intaglio printing method, and a gravure printing method. Any appropriate drying method (such as natural drying, blast drying, or heat drying) can be adopted as a method of drying the applied layer. In the case of, for example, the heat drying, a drying temperature is typically from 100° C. to 200° C. and a drying time is typically from 1 minute to 10 minutes.

When the transparent conductive layer includes the conductive nanowire, the thickness of the transparent conductive layer is preferably from 0.01 μm to 10 μm, more preferably from 0.05 μm to 3 μm, particularly preferably from 0.1 μm to 1 μm. When the thickness falls within such range, a conductive film excellent in conductivity and light transmittance can be obtained.

When the transparent conductive layer includes the conductive nanowire, the total light transmittance of the transparent conductive layer is preferably 85% or more, more preferably 90% or more, still more preferably 95% or more.

The content of the conductive nanowire in the transparent conductive layer is preferably from 80 wt % to 100 wt %, more preferably from 85 wt % to 99 wt % with respect to the total weight of the transparent conductive layer. When the content falls within such range, a conductive film excellent in conductivity and light transmittance can be obtained.

When the conductive nanowire is a metal nanowire containing silver, the density of the transparent conductive layer is preferably from 1.3 g/cm³ to 10.5 g/cm³, more preferably from 1.5 g/cm³ to 3.0 g/cm³. When the density falls within such range, a conductive film excellent in conductivity and light transmittance can be obtained.

The transparent conductive layer including the conductive nanowire can be patterned into a predetermined pattern. The shape of the pattern of the transparent conductive layer is preferably a pattern that satisfactorily operates as a touch panel (e.g., a capacitance-type touch panel), and examples thereof include patterns described in JP 2011-51.1357 A, JP 201.0-164938 A, JP 2008-310550 A, JP 2003-511799 A, and JP 2010-541109 A. The transparent conductive layer can be patterned by employing a known method after having been formed on a transparent base material.

C-2. Metal. Mesh

The transparent conductive layer including the metal mesh is obtained by forming a thin metal wire into a lattice pattern on the retardation film.

As a metal constituting the metal mesh, any appropriate metal may be used as long as the metal has high conductivity. The metal mesh preferably contains one or more kinds of metals selected from the group consisting of gold, platinum, silver, and copper. Of those, from the viewpoint of conductivity, silver, copper, or gold is preferred, and silver is more preferred.

The transparent conductive layer including the metal mesh can be formed by any appropriate method. The transparent conductive layer can be obtained by, for example, applying a photosensitive composition (composition for forming a transparent conductive layer) containing a silver salt onto the retardation film, and then subjecting the resultant to an exposure treatment and a developing treatment to form the thin metal wire into a predetermined pattern. In addition, the transparent conductive layer can be obtained by printing a paste (composition for forming a transparent conductive layer) containing metal fine particles into a predetermined pattern. Details about such transparent conductive layer and a formation method therefor are described in, for example, JP 2012-18634 A, and the description is incorporated herein by reference. In addition, other examples of the transparent conductive layer including the metal mesh and the formation method therefor include a transparent conductive layer and a formation method therefor described in JP 2003-331654 A.

When the transparent conductive layer includes the metal mesh, the thickness of the transparent conductive layer is preferably from 0.01 μm to 10 μm, more preferably from 0.05 μm to 3 μm, particularly preferably from 0.1 μm to 1 μm.

When the transparent conductive layer includes the metal mesh, the transmittance of the transparent conductive layer is preferably 80% or more, more preferably 85% or more, still more preferably 90% or more.

C-3. Conductive Polymer

The transparent conductive layer including the conductive polymer can be formed by applying a conductive composition containing the conductive polymer onto the retardation film.

Examples of the conductive polymer include a polythiophene-based polymer, a polyacetylene-based polymer, a poly-p-phenylene-based polymer, a polyaniline-based polymer, a poly-p-phenylene vinylene-based polymer, a polypyrrole-based polymer, a polyphenylene-based polymer, and a polyester-based polymer modified with an acrylic polymer. The transparent conductive layer preferably includes one or more kinds of polymers selected from the group consisting of a polythiophene-based polymer, a polyacetylene-based polymer, a poly-p-phenylene-based polymer, a polyaniline-based polymer, a poly-p-phenylene vinylene-based polymer, and a polypyrrole-based polymer.

A polythiophene-based polymer is more preferably used as the conductive polymer. A transparent conductive layer excellent in transparency and chemical, stability can be formed when the polythiophene-based polymer is used. Specific examples of the polythiophene-based polymer include: polythiophene; a poly(3-C₁₋₈ alkyl-thiophene) such as poly(3-hexylthiophene); poly(3,4-(cyclo)alkylenedioxythiophene)s such as poly(3,4-ethylenedioxythiophene), poly(3,4-propylenedioxythiophene), and poly[3,4-(1,2-cyclohexylene)dioxythiophene]; and polythienylene vinylene.

The conductive polymer is preferably polymerized in the presence of an anionic polymer. For example, the polythiophene-based polymer is preferably oxidatively polymerized in the presence of an anionic polymer. An example of the anionic polymer is a polymer having a carboxyl group, a sulfonic acid group, and/or a salt thereof. Of those, an anionic polymer having a sulfonic acid group such as polystyrenesulfonic acid is preferably used.

The conductive polymer, the transparent conductive layer including the conductive polymer, and a method of forming the transparent conductive layer are described in, for example, JP 2011-175601 A, and the description is incorporated herein by reference.

When the transparent conductive layer includes the conductive polymer, the thickness of the transparent conductive layer is preferably from 0.01 μm to 1 μm, more preferably from 0.01 μm to 0.5 μm, still more preferably from 0.03 μm to 0.3 μm.

When the transparent conductive layer includes the conductive polymer, the transmittance of the transparent conductive layer is preferably 80% or more, more preferably 85% or more, still more preferably 90% or more.

D. Other Layer

The conductive film may include any appropriate other layer as required. Examples of the other layer include a hard coat layer, an antistatic layer, an antiglare layer, an antireflection layer, and a color filter layer.

The hard coat layer has a function of imparting chemical resistance, scratch resistance, and surface smoothness to the retardation film.

Any appropriate material can be adopted as a material constituting the hard coat layer. Examples of the material constituting the hard coat layer include an epoxy-based resin, an acrylic resin, and a silicone-based resin, and a mixture thereof. Of those, an epoxy-based resin excellent in heat resistance is preferred. The hard coat layer can be obtained by curing any such resin with heat or an active energy ray.

E. Image Display Apparatus

The conductive film can be used in an electronic device such as an image display apparatus. More specifically, the conductive film can be used as, for example, an electrode to be used in a touch panel or the like, or an electromagnetic wave shield for blocking an electromagnetic wave responsible for the malfunction of an electronic device.

FIG. 2 is a schematic sectional view for illustrating an example of an image display apparatus (liquid crystal, display apparatus) including the conductive film of the present invention. An image display apparatus 100 includes the conductive film 10 of the present invention and a polarizing plate 20 in the stated order from a viewer side. The polarizing plate 20 is a member constituting a liquid crystal panel 120. Any appropriate liquid crystal panel can be used as the liquid crystal panel. A liquid crystal panel having two polarizing plates 20 and 20′, and a liquid crystal cell 30 arranged between the two polarizing plates like the illustrated example can be typically used. In the image display apparatus including a display element that outputs linearly polarized light, the conductive film of the present invention is arranged on the viewer side of the display element and hence can contribute to an improvement in visibility through a polarizing lens. It should be noted that any appropriate polarizing plates and liquid crystal cell can be used as the polarizing plates and the liquid crystal cell. In addition, the liquid crystal panel may further include any appropriate other member.

In the image display apparatus 100, the conductive film 10 is a member constituting a capacitance-type touch panel 110. The touch panel 110 includes a cover panel 40, the conductive film 10, an isotropic film 50, and another transparent conductive layer 2′ in the stated order from the viewer side. The conductive film 10 is arranged so that the retardation film 1 may be present on the viewer side. The touch panel may further include any appropriate other member.

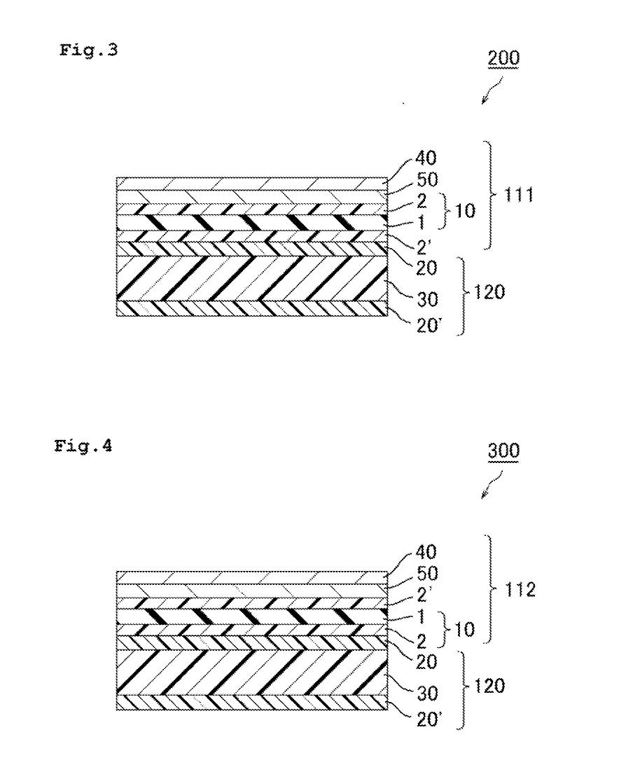

FIG. 3 is a schematic sectional view for illustrating another example of the image display apparatus (liquid crystal display apparatus) including the conductive film of the present invention. An image display apparatus 200 includes the liquid crystal panel 120 and a capacitance-type touch panel 111. The touch panel 111 includes the cover panel 40, the isotropic film 50, the conductive film 10, and the other transparent conductive layer 2′ in the stated order from the viewer side. The conductive film 10 is arranged so that the retardation film 1 may be present on a side opposite to the viewer side.

FIG. 4 is a schematic sectional view for illustrating another example of the image display apparatus (liquid crystal display apparatus) including the conductive film of the present invention. An image display apparatus 300 includes the liquid crystal panel 120 and a capacitance-type touch panel 112. The touch panel 112 includes the cover panel 40, the isotropic film 50, the other transparent conductive layer 2′, and the conductive film 10 in the stated order from the viewer side. The conductive film 10 is arranged so that the retardation film 1 may be present on the viewer side.

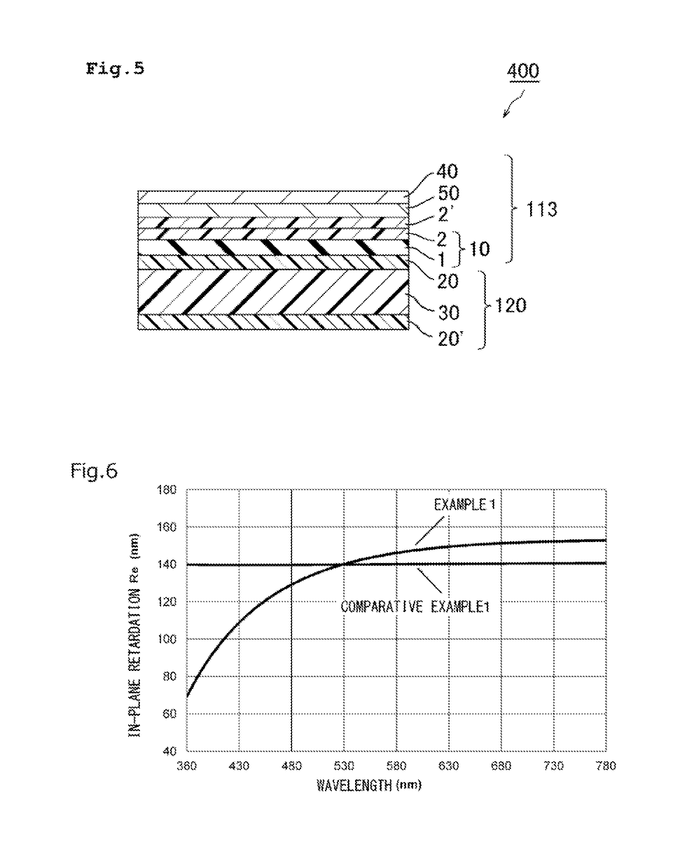

FIG. 5 is a schematic sectional view for illustrating another example of the image display apparatus (liquid crystal display apparatus) including the conductive film of the present invention. An image display apparatus 400 includes the liquid crystal panel 120 and a capacitance-type or resistance film-type touch panel 113. The touch panel 113 includes the cover panel 40, the isotropic film 50, the other transparent conductive layer 2′, and the conductive film 10 in the stated order from the viewer side. The conductive film 10 is arranged so that the retardation film 1 may be present on a side opposite to the viewer side. It should be noted that when the touch panel. 113 is a resistance film-type touch panel, an air layer is formed by arranging a spacer between the transparent conductive layer 2 of the conductive film 10 and the other transparent conductive layer 2′.

The polarizing plates 20 and 20′ each preferably have a polarizer and a protective film for protecting the polarizer on at least one surface of the polarizer.

Any appropriate polarizer is used as the polarizer. Examples thereof include: a polarizer obtained by causing a hydrophilic polymer film such as a polyvinyl alcohol-based film, a partially formalized polyvinyl alcohol-based film, or an ethylene/vinyl acetate copolymer-based partially saponified film to adsorb a dichromatic substance such as iodine or a dichromatic dye and uniaxially stretching the resultant; and polyene-based oriented films such as a dehydration treatment product of polyvinyl alcohol and a dehydrochlorination treatment product of polyvinyl chloride. Of those, a polarizer obtained by causing a polyvinyl alcohol-based film to adsorb a dichromatic substance such as iodine and uniaxially stretching the resultant is particularly preferred because of its high polarization dichroic ratio. The thickness of the polarizer is preferably from 0.5 μm to 80 μm.

The polarizer obtained by causing the polyvinyl alcohol-based film to adsorb iodine and uniaxially stretching the resultant is typically produced by immersing polyvinyl alcohol in an aqueous solution of iodine to dye the alcohol and stretching the resultant at a ratio of from 3 times to 7 times with respect to the original length. The stretching may be performed after the dyeing, the stretching maybe performed while the dyeing is performed, or the stretching may be performed before the dyeing. The polarizer is produced by subjecting the film to a treatment such as swelling, cross-linking, adjustment, water washing, or drying in addition to the stretching and the dyeing.

Any appropriate film is used as the protective film. As a material as a main component of such film, there are specifically given, for example, a cellulose-based resin such as triacetylcellulose (TAC), and transparent resins such as (meth)acrylic, polyester-based, polyvinyl alcohol-based, polycarbonate-based, polyamide-based, polyimide-based, polyether sulfone-based, polysulfone-based, polystyrene-based, polynorbornene-based, polyolefin-based, or acetate-based transparent resins. In addition, additional examples thereof include a thermosetting resin or a UV curing resin such as an acrylic, urethane-based, acrylic urethane-based, epoxy-based, or silicone-based thermosetting resin or UV-curable resin as well as a glassy polymer such as a siloxane-based polymer. In addition, a polymer film described in JP 2001-343529 A (WO 01/37007 A1) can be used. For example, a resin composition containing a thermoplastic resin having a substituted or unsubstituted imide group on a side chain thereof, and a thermoplastic resin having a substituted or unsubstituted phenyl group and a nitrile group on side chains thereof can be used as a material for the film, and the composition is, for example, a resin composition having an alternating copolymer formed of isobutene and N-methylmaleimide, and an acrylonitrile-styrene copolymer. The polymer film can be, for example, an extrudate of the resin composition.

An angle formed between the absorption axis of the polarizer of the polarizing plate and the slow axis of the retardation film is set to preferably from 40° to 50°, more preferably from 42° to 48°, still more preferably from 44° to 46°. When the retardation film is arranged so that the angle between the axes may fall within such range, an image display apparatus additionally excellent in visibility through a polarizing lens can be obtained.

The cover panel 40 includes, for example, a glass or a resin sheet. The thickness of the cover panel 40 is preferably from 100 μm to 5,000 μm.

As a material constituting the isotropic film 50, there are given, for example: a norbornene-based resin; a cellulose-based resin such as cellulose ester; and an acrylic resin such as polymethyl methacrylate. The term “isotropic film” as used herein refers to a film showing a small optical difference depending on three-dimensional directions and substantially free of showing anisotropic optical properties such as birefringence. It should be noted that the phrase “substantially free of showing anisotropic optical properties” means that even the case where birefringence is slightly present is included in isotropy as long as the birefringence does not adversely affect the display characteristics of the liquid crystal display apparatus in practical use.

The thickness of the isotropic film 50 is preferably from 10 μm to 100 μm, more preferably from 10 μm to 80 μm, particularly preferably from 10 μm to 50 μm. When the thickness falls within such range, an isotropic film excellent in mechanical strength and display uniformity can be obtained.

The same transparent conductive layer as the transparent conductive layer described in the section C can be used as the other transparent conductive layer 2′. The other transparent conductive layer 2′ and the transparent conductive layer 2 of the conductive film 10 may be of the same construction, or may be of different constructions.

An image display apparatus including a liquid crystal panel is illustrated in each of FIG. 2 to FIG. 5, but any appropriate display element can be used instead of the liquid crystal panel. For example, the image display apparatus of the present invention maybe an image display apparatus (organic EL image display apparatus) including an organic electroluminescence element having a polarizing plate.

As illustrated in each of FIG. 2 to FIG. 5, the image display apparatus of the present invention is preferably such that no polarizing plate is arranged on the viewer side of the conductive film. With such construction, when an image is viewed through a pair of polarizing glasses, the image can be satisfactorily viewed irrespective of an angle formed between the absorption axis of the polarizing plate of the image display apparatus and the absorption axis of the pair of polarizing glasses.

### EXAMPLES

Now, the present invention is specifically described by way of Examples. However, the present invention is by no means limited to Examples described below. Evaluation methods in Examples are as described below. It should be noted that a thickness was measured with Peacock Precision Measuring Instrument Digital Gauge Cordless Type “DG-205” manufactured by Ozaki Mfg Co., Ltd.

(1) Retardation Value

Measurement was performed with a product available under the trade name “KOBRA-WPR” from Oji Scientific Instruments. A measurement temperature was set to 23° C.

(2) Surface Resistance Value

Measurement was performed with a product available under the trade name “Loresta-GP MCP-T610” from Mitsubishi Chemical Analytech Co., Ltd. by a four-terminal method. A measurement temperature was set to 23° C.

(3) Total Light Transmittance

Measurement was performed with a product available under the trade name “HR-100” from Murakami Color Research Laboratory Co., Ltd. at 23° C. The measurement was repeated three times and the average of the three values was defined as a measured value.

(4) Observation Through Pair of Polarizing Sunglasses

The retardation film side of a conductive film was bonded onto a polarizing plate (manufactured by Nitto Denko Corporation, trade name: “NPF-SEG1425DU”), and the side of the polarizing plate opposite to the surface having bonded thereto the conductive film was placed on a backlight. The laminate of the polarizing plate and the conductive film was caused to transmit colorless light, and the transmitted light was visually observed through a pair of polarizing glasses.

When a retardation film having a retardation in its plane was used, the retardation film and the polarizing plate were bonded to each other so that an angle formed between the slow axis of the film and the absorption axis of the plate became 45°.

(5) Bending Resistance Test

The conductive film was cut so as to measure 1 cm by 15 cm, and electrodes each formed of a Ag paste were arranged on both ends in its lengthwise direction. The conductive film was suspended on a stainless steel bar having a diameter of 3 mm so that the lengthwise direction of the stainless steel bar and the lengthwise direction of the conductive film were perpendicular to each other, and the transparent conductive layer was present on an outer side. The conductive film was bent for 10 seconds by applying a load of 500 g to each of both ends in the lengthwise direction.

A change in surface resistance value of the conductive film after the test as compared to its surface resistance value before the test was measured with a product available under the trade name “Digital Multimeter CD800a” from Sanwa Electric Instrument Co., Ltd.

### Example 1

### Synthesis of Silver Nanowire and Preparation of Silver Nanowire Dispersion Liquid

5 Milliliters of anhydrous ethylene glycol and 0.5 ml of a solution of PtCl₂ in anhydrous ethylene glycol (concentration: 1.5×10⁻⁴ mol/L) were added to a reaction vessel equipped with a stirring device under 160° C. After a lapse of 4 minutes, 2.5 ml of a solution of AgNO₃ in anhydrous ethylene glycol (concentration: 0.12 mol/l) and 5 ml of a solution of polyvinyl pyrrolidone (MW: 5,500) in anhydrous ethylene glycol (concentration: 0.36 mol/l) were simultaneously dropped to the resultant solution over 6 minutes to produce a silver nanowire. The dropping was performed under 160° C. until AgNO₃ was completely reduced. Next, acetone was added to the reaction mixture containing the silver nanowire obtained as described above until the volume of the reaction mixture became 5 times as large as that before the addition. After that, the reaction mixture was centrifuged (2,000 rpm, 20 minutes). Thus, a silver nanowire was obtained.

The resultant silver nanowire had a short diameter of from 30 nm to 40 nm, a long diameter of from 30 nm to 50 nm, and a length of from 30 μm to 50 μm.

A silver nanowire dispersion liquid was prepared by dispersing the silver nanowire (concentration: 0.2 wt %) and dodecyl-pentaethylene glycol (concentration: 0.1 wt %) in pure water.

(Production of Conductive Film)

A stretched polycarbonate film (manufactured by Teijin Chemicals Ltd., trade name: “PURE-ACE”, in-plane retardation Re at a wavelength of 550 nm: 147 nm, in-plane retardation Re at a wavelength of 400 nm: 88 nm, thickness direction retardation Rth at a wavelength of 550 nm: 67 nm, thickness: 40 μm) was used as a retardation film.

The silver nanowire dispersion liquid was applied onto the retardation film with a bar coater (manufactured by Dai-ichi Rika Co., Ltd., product name: “Bar Coater No. 09”), and was dried in a fan dryer at 120° C. for 2 minutes to form a transparent conductive layer having a thickness of 0.1 μm.

The conductive film had a surface resistance value of 189Ω/□, a total light transmittance of 90.4%.

The resultant conductive film was subjected to a bending resistance test. As a result, no increase in surface resistance value was observed.

Observation through a pair of polarizing sunglasses was performed. As a result, transmitted light was able to be normally viewed no matter how an angle formed between the absorption axis of the polarizer of the polarizing plate and the absorption axis of the pair of polarizing glasses was set.

### Example 2

A conductive film (retardation film (thickness: 40 μm)/transparent conductive layer (thickness: 0.05 μm)) was obtained in the same manner as in Example 1 except that a PEDOT/PSS dispersion liquid (manufactured by Heraeus, trade name: “Clevios FE-T”; a dispersion liquid of a conductive polymer containing polyethylenedioxythiophene and polystyrenesulfonic acid) was used instead of the silver nanowire dispersion liquid.

The conductive film had a surface resistance value of 457Ω/□, a total light transmittance of 89.2.

The resultant conductive film was subjected to a bending resistance test. As a result, no increase in surface resistance value was observed.

Observation through a pair of polarizing sunglasses was performed. As a result, transmitted light was able to be normally viewed no matter how an angle formed between the absorption axis of the polarizer of the polarizing plate and the absorption axis of the pair of polarizing glasses was set.

### Example 3

The surface of the retardation film (stretched polycarbonate film) used in Example 1 was hydrophilized by performing a corona treatment. After that, a metal mesh (line width: 8.5 μm, lattice having a pitch of 300 μm) was formed by using a silver paste (manufactured by Toyochem Co., Ltd., trade name: “RA FS 039”) by a screen printing method, and was sintered at 120° C. for 10 minutes. Thus, a transparent conductive film was obtained.

The transparent conductive film had a surface resistance value of 205Ω/□, a total light transmittance of 87.4%.

The resultant conductive film was subjected to a bending resistance test. As a result, no increase in surface resistance value was observed.

Observation through a pair of polarizing sunglasses was performed. As a result, transmitted light was able to be normally viewed no matter how an angle formed between the absorption axis of the polarizer of the polarizing plate and the absorption axis of the pair of polarizing glasses was set.

### Comparative Example 1

A conductive film (retardation film (thickness: 33 μm)/transparent conductive layer (thickness: 0.1 μm)) was obtained in the same manner as in Example 1 except that a film obtained by uniaxially stretching a norbornene-based cycloolefin film (manufactured by Zeon Corporation, trade name: “ZEONOR”) so that its in-plane retardation Re at a wavelength of 560 nm became 140 nm was used instead of the stretched polycarbonate film as the retardation film.

The retardations of the retardation film were as described below.

In-plane retardation at a wavelength of 550 nm: 140 nm
In-plane retardation at a wavelength of 400 nm: 140 nm
Thickness direction retardation at a wavelength of 550 nm: 65 nm

The conductive film had a surface resistance value of 201Ω/□, a total light transmittance of 90.5%.

The resultant conductive film was subjected to a bending resistance test. As a result, no increase in surface resistance value was observed.

Observation through a pair of polarizing sunglasses was performed. As a result, transmitted light was able to be normally viewed when the absorption axis of the polarizer of the polarizing plate and the absorption axis of the pair of polarizing glasses were parallel to each other, but the transmitted light colored in the case of any other axial relationship.

### Comparative Example 2

A conductive film (retardation film (thickness: 33 μm)/transparent conductive layer (thickness: 0.1 μm)) was obtained in the same manner as in Example 2 except that the retardation film used in Comparative Example 1 was used as the retardation film.

The conductive film had a surface resistance value of 457Ω/□, a total light transmittance of 89.2%.

The resultant conductive film was subjected to a bending resistance test. As a result, no increase in surface resistance value was observed.

Observation through a pair of polarizing sunglasses was performed. As a result, transmitted light was able to be normally viewed when the absorption axis of the polarizer of the polarizing plate and the absorption axis of the pair of polarizing glasses were parallel to each other, but the transmitted light colored in the case of any other axial relationship.

### Comparative Example 3

A conductive film (retardation film (thickness: 33 μm)/transparent conductive layer (thickness: 0.10 μm)) was obtained in the same manner as in Example 3 except that the retardation film used in Comparative Example 1 was used as the retardation film.

The conductive film had a surface resistance value of 197Ω/□, a total light transmittance of 87.3%.

The resultant conductive film was subjected to a bending resistance test. As a result, no increase in surface resistance value was observed.

Observation through a pair of polarizing sunglasses was performed. As a result, transmitted light was able to be normally viewed when the absorption axis of the polarizer of the polarizing plate and the absorption axis of the pair of polarizing glasses were parallel to each other, but the transmitted light colored in the case of any other axial relationship.

### Comparative Example 4

A conductive film was obtained in the same manner as in Example 1 except that a norbornene-based cycloolefin film (manufactured by Zeon Corporation, trade name: “ZEONOR”, in-plane retardation Re at a wavelength of 550 nm: 1.7 nm, in-plane retardation Re at a wavelength of 400 nm: 1.7 nm, thickness direction retardation Rth at a wavelength of 550 nm: 1.8 nm, thickness: 40 μm) was used instead of the stretched polycarbonate film as a retardation film.

The conductive film had a surface resistance value of 212Ω/□, a total light transmittance of 90.6%.

Observation through a pair of polarizing sunglasses was performed. As a result, transmitted light could not be viewed when the absorption axis of the polarizer of the polarizing plate and the absorption axis of the pair of polarizing sunglasses were perpendicular to each other.

### Comparative Example 5

A conductive film was obtained in the same manner as in Example 2 except that the norbornene-based cycloolefin film used in Comparative Example 4 was used as the retardation film.

The conductive film had a surface resistance value of 476Ω/□, a total light transmittance of 89.3%.

Observation through a pair of polarizing sunglasses was performed. As a result, transmitted light could not be viewed when the absorption axis of the polarizer of the polarizing plate and the absorption axis of the pair of polarizing sunglasses were perpendicular to each other.

### Comparative Example 6

A conductive film was obtained in the same manner as in Example 3 except that the norbornene-based cycloolefin film used in Comparative Example 4 was used as the retardation film.

The conductive film had a surface resistance value of 201Ω/□, a total light transmittance of 86.3%.

Observation through a pair of polarizing sunglasses was performed. As a result, transmitted light could not be viewed when the absorption axis of the polarizer of the polarizing plate and the absorption axis of the pair of polarizing sunglasses were perpendicular to each other.

### Comparative Example 7

A conductive film was obtained in the same manner as in Example 1 except that an acrylic polymer film (manufactured by Kaneka Corporation, trade name: “HX-40NC”, in-plane retardation Re at a wavelength of 550 nm: 0.7 nm, in-plane retardation Re at a wavelength of 400 nm: 0.7 nm, thickness direction retardation Rth at a wavelength of 550 nm: −0.3 nm, thickness: 40 μm) was used instead of the stretched polycarbonate film as a retardation film.

The conductive film had a surface resistance value of 224Ω/□, a total light transmittance of 90.7%.

Observation through a pair of polarizing sunglasses was performed. As a result, transmitted light could not be viewed when the absorption axis of the polarizer of the polarizing plate and the absorption axis of the pair of polarizing sunglasses were perpendicular to each other.

### Comparative Example 8

A conductive film was obtained in the same manner as in Example 2 except that the acrylic polymer film used in Comparative Example 7 was used instead of the stretched polycarbonate film.

The conductive film had a surface resistance value of 461Ω/□, a total light transmittance of 89.4%.

Observation through a pair of polarizing sunglasses was performed. As a result, transmitted light could not be viewed when the absorption axis of the polarizer of the polarizing plate and the absorption axis of the pair of polarizing sunglasses were perpendicular to each other.

### Comparative Example 9

A conductive film was obtained in the same manner as in Example 3 except that the acrylic polymer film used in Comparative Example 7 was used instead of the stretched polycarbonate film.

The conductive film had a surface resistance value of 223Ω/□, a total light transmittance of 88.4%.

Observation through a pair of polarizing sunglasses was performed. As a result, transmitted light could not be viewed when the absorption axis of the polarizer of the polarizing plate and the absorption axis of the pair of polarizing sunglasses were perpendicular to each other.

### Comparative Example 10

A conductive film was obtained in the same manner as in Example 1 except that a PET film (manufactured by Mitsubishi Resin, trade name: “DIAFOIL T602”, in-plane retardation Re at a wavelength of 550 nm: 1,862 nm, in-plane retardation Re at a wavelength of 400 nm: 1,862 nm, thickness direction retardation Rth at a wavelength of 550 nm: 6,541 nm, thickness: 60 μm) was used instead of the stretched polycarbonate film as a retardation film.

The conductive film had a surface resistance value of 221Ω/□, a total light transmittance of 90.9%.

Observation through a pair of polarizing sunglasses was performed. As a result, transmitted light colored and showed a rainbow patchy pattern no matter how an angle formed between the absorption axis of the polarizer of the polarizing plate and the absorption axis of the pair of polarizing sunglasses was set, and hence an image could not be normally viewed.

### Comparative Example 11

A conductive film was obtained in the same manner as in Example 2 except that the PET film used in Comparative Example 10 was used as the retardation film.

The conductive film had a surface resistance value of 467Ω/□, a total light transmittance of 89.7%.

Observation through a pair of polarizing sunglasses was performed. As a result, transmitted light colored and showed a rainbow patchy pattern no matter how an angle formed between the absorption axis of the polarizer of the polarizing plate and the absorption axis of the pair of polarizing sunglasses was set, and hence an image could not be normally viewed.

### Comparative Example 12

A conductive film was obtained in the same manner as in Example 3 except that the PET film used in Comparative Example 10 was used as the retardation film.

The conductive film had a surface resistance value of 221Ω/□, a total light transmittance of 87.7%.

Observation through a pair of polarizing sunglasses was performed. As a result, transmitted light colored and showed a rainbow patchy pattern no matter how an angle formed between the absorption axis of the polarizer of the polarizing plate and the absorption axis of the pair of polarizing sunglasses was set, and hence an image could not be normally viewed.

### Comparative Example 13

A norbornene-based cycloolefin film (manufactured by Zeon Corporation, trade name: “ZEONOR”) was used as a retardation film.

An indium tin oxide layer having a thickness of 17 nm was formed on one surface of the base material of the retardation film with a sputtering apparatus including a sintered body target containing 97 mass % of indium oxide and 3 mass % of tin oxide. In addition, an indium tin oxide layer having a thickness of 17 nm was formed on the other surface of the film by the same method. The film base material on both surfaces of which the indium tin oxide layers had been thus formed was loaded into a heating oven and subjected to a heat treatment at 140° C. for 30 minutes. Thus, the amorphous indium tin oxide layers were crystallized. The surface resistance value of each of the resultant indium tin oxide layers was measured to be 133 Ω/□.

The resultant conductive film was subjected to a bending resistance test. As a result, its surface resistance value increased by a factor of 9.5 as compared to that before the test.

The constructions and evaluation results of Examples 1 and 2, and Comparative Examples 1 to 12 are summarized in Table 1. In addition, the wavelength dispersion characteristics of the retardation film used in Example 1 (and in Examples 2 and 3), and the retardation film used in Comparative Example 1 (and in Comparative Examples 2 and 3) are shown in FIG. 6.

TABLE 1

| | | | | | | | | Observation through pair | |
|---|---|---|---|---|---|---|---|---|---|
| | | | | | | | | of polarizing sunglasses | |
| | | | | | | Surface | | When | When |
| | Retardation film | | | | Transparent | resistance | Trans- | polarizing | polarizing |
| | Re[550] | Re[400] | Re[400]/ | Rth | conductive | value | mittance | plate is | plate is |
| | (nm) | (nm) | Re[550] | (nm) | layer | (Ω/□) | (%) | perpendicular | parallel |
| Example 1 | 147 | 88 | 0.6 | 67 | Silver | 189 | 90.4 | Normal | Normal |
| | | | | | nanowire | | | | |
| Example 2 | 147 | 88 | 0.6 | 67 | PEDOT/PSS | 457 | 89.2 | Normal | Normal |
| Example 3 | 147 | 88 | 0.6 | 67 | Metal mesh | 205 | 87.4 | Normal | Normal |
| Comparative | 140 | 140 | 1.0 | 65 | Silver | 201 | 90.5 | Coloring | Normal |
| Example 1 | | | | | nanowire | | | | |
| Comparative | 140 | 140 | 1.0 | 65 | PEDOT/PSS | 457 | 89.2 | Coloring | Normal |
| Example 2 | | | | | | | | | |
| Comparative | 140 | 140 | 1.0 | 65 | Metal mesh | 197 | 87.3 | Coloring | Normal |
| Example 3 | | | | | | | | | |
| Comparative | 1.7 | 1.7 | 1.0 | 1.8 | Silver | 212 | 90.6 | Unable to view | Normal |
| Example 4 | | | | | nanowire | | | | |
| Comparative | 1.7 | 1.7 | 1.0 | 1.8 | PEDOT/PSS | 476 | 89.3 | Unable to view | Normal |
| Example 5 | | | | | | | | | |
| Comparative | 1.7 | 1.7 | 1.0 | 1.8 | Metal mesh | 201 | 86.3 | Unable to view | Normal |
| Example 6 | | | | | | | | | |
| Comparative | 0.7 | 0.7 | 1.0 | −0.3 | Silver | 224 | 90.7 | Unable to view | Normal |
| Example 7 | | | | | nanowire | | | | |
| Comparative | 0.7 | 0.7 | 1.0 | −0.3 | PEDOT/PSS | 461 | 89.4 | Unable to view | Normal |
| Example 8 | | | | | | | | | |
| Comparative | 0.7 | 0.7 | 1.0 | −0.3 | Metal mesh | 223 | 88.4 | Unable to view | Normal |
| Example 9 | | | | | | | | | |
| Comparative | 1,862 | 1,862 | 1.0 | 6,541 | Silver | 221 | 90.9 | Unable to view | Unable to view |
| Example 10 | | | | | nanowire | | | (rainbow patch) | (rainbow patch) |
| Comparative | 1,862 | 1,862 | 1.0 | 6,541 | PEDOT/PSS | 467 | 89.7 | Unable to view | Unable to view |
| Example 11 | | | | | | | | (rainbow patch) | (rainbow patch) |
| Comparative | 1,862 | 1,862 | 1.0 | 6,541 | Metal mesh | 221 | 87.7 | Unable to view | Unable to view |
| Example 12 | | | | | | | | (rainbow patch) | (rainbow patch) |

### REFERENCE SIGNS LIST

1 retardation film
2 transparent conductive layer
10 conductive film
20 polarizing plate
30 liquid crystal cell
40 cover panel
50 isotropic film
100 image display apparatus

1-8. (canceled)

9. A conductive film, comprising:
a retardation film; and
a transparent conductive layer arranged on at least one surface of the retardation film,
wherein:
the retardation film has an in-plane retardation at a wavelength of 550 nm of from 90 nm to 190 nm;
a ratio (Re[400]/Re[550]) of an in-plane retardation Re[400] of the retardation film at a wavelength of 400 nm to the in-plane retardation Re[550] of the retardation film at a wavelength of 550 nm is from 0.5 to 0.9; and
the transparent conductive layer comprises at least one kind selected from the group consisting of a conductive nanowire, a metal mesh, and a conductive polymer.

10. The conductive film according to claim 9, wherein the conductive nanowire or the metal mesh contains one or more kinds of metals selected from the group consisting of gold, platinum, silver, and copper.

11. The conductive film according to claim 9, wherein the conductive nanowire contains a carbon nanotube.

12. The conductive film according to claim 9, wherein a ratio (L/d) of a length L of the conductive nanowire to a thickness d of the conductive nanowire is from 10 to 100,000.

13. The conductive film according to claim 9, wherein the conductive polymer comprises one or more kinds of polymers selected from the group consisting of a polythiophene-based polymer, a polyacetylene-based polymer, a poly-p-phenylene-based polymer, a polyaniline-based polymer, a poly-p-phenylene vinylene-based polymer, and a polypyrrole-based polymer.

14. An image display apparatus, comprising the conductive film of claim 9 and a polarizing plate in the stated order from a viewer side.

15. The image display apparatus according to claim 14, wherein the image display apparatus is free of a polarizing plate arranged on the viewer side of the conductive film.

16. A touch panel, comprising the conductive film of claim 9.
